(19) United States
(12) Patent Application Publication
(10) Pub. No.: US 2021/0065233 A1
(43) Pub. Date: Mar. 4, 2021

(54) INTERFACE METHOD AND SYSTEM FOR ENABLING AN ADVERTISEMENT SPONSOR TO INPUT DATA CONCERNING LEADS GENERATED IN RESPONSE TO ADVERTISEMENTS

(71) Applicants: Jacob M. DelHagen, Easthampton, MA (US); Mark E. Salomone, Longmeadow, MA (US)

(72) Inventors: Jacob M. DelHagen, Easthampton, MA (US); Mark E. Salomone, Longmeadow, MA (US)

(73) Assignee: SherloQ, Inc., Holyoke, MA (US)

(21) Appl. No.: 17/096,291

(22) Filed: Nov. 12, 2020

Related U.S. Application Data
(62) Division of application No. 16/351,102, filed on Mar. 12, 2019.

(51) Int. Cl. G06Q 30/02; G06F 3/0482; G06F 9/54; G06F 3/0481; G06F 3/0488

(52) U.S. Cl. CPC G06Q 30/0243; G06F 3/0482; G06F 3/04883; G06F 3/04817; G06F 9/547

(57) ABSTRACT

A method and system for controlling a display enables the sponsor of an advertisement to score displayed leads by either swiping left of right in the area of a touchscreen where the lead is displayed, to move a slider to indicate a value of the lead, or to otherwise input a score or rating. The method and system also allows a user to verify the accuracy of a displayed lead type identification, and to submit a corrected lead type identification to the provider if the initial identification is incorrect, for use as input to a neural network that performs the lead type identification.

This application is a divisional of U.S. patent application Ser. No. 16/351,102, filed Sep. 17, 2019, and incorporated herein by reference.

### BACKGROUND OF THE INVENTION

### 1. Field of the Invention

The invention relates to a system and method that analyzes advertisement effectiveness, and in particular to an interface that allows a sponsor of an advertisement to input data to an advertisement management and analysis system. The input data may include data concerning the value of leads generated in response to the advertisement, after or during follow-up by the sponsor, and/or data to assist the advertising analysis system and method in identifying leads.

The interface may be in the form of a graphical user interface implemented on a mobile device, such as a smartphone or tablet, by a mobile “app,” software, or firmware. The interface may also be implemented on a personal computer or network-connected terminal.

### 2. Description of Related Art

Systems and methods for measuring or analyzing the effectiveness of advertisements have long been used to set prices for the advertisements and assist in their design, timing, and media selection, based for example, on the number and demographics of viewers, the response rate, and whether a response results in a completed transaction.

Conventionally, the analysis has involved automated input of data by counting click-throughs, which are a measure of the number of times that an advertisement has been selected and viewed, and completed transactions. Other response data inputs include automated tracking of telephone calls to a designated number, and tabulation of online survey results. However, many businesses rely not just on direct responses to advertisements, but on follow-up to leads generated by the direct responses, and in particular on human interactions with responders, either in person, by telephone, by e-mail, by a live chat session, by text messaging, or any combination of interactions. Such leads cannot be tracked by conventional automated advertising data collection. For example, engagement of a legal services provider may require multiple telephone, live chat, and/or in-person interactions before the nature of the services sought can even be determined. In addition, the nature of the services to be provided may be subject to confidentiality or privilege, making it impossible to record and perform a detailed analysis of the responses without input from the legal services provider. Similar difficulties may be presented in the case of physicians, clinics, and other businesses verticals that are permitted to advertise their services or products. Nevertheless, such advertising sponsors still have an interest in determining the effectiveness of advertisements that they sponsor. As a result, there is a need to provide a way for the sponsor to input effective data that allows leads to be characterized and the characterizations to be manually input to an advertisement management or analysis system, in order to supplement automated data collection, and also to improve the ability to recognize leads for follow-up and characterization.

This need is not met by any advertising management or analysis products currently on the market. By way of background, the following are examples of patents and publications that disclosing advertisement managing, scoring, and/or analysis apps or software together with automated data collection, but that fail to provide for manual input of lead-characterizing information by an advertisement sponsor, or to provide for sponsor input of data related to training or refinement of the analysis:

U.S. Patent Publication No. 2007/0157229 is of background interest for its disclosure of software that analyzes click data and telephone responses to a dedicated central number, while U.S. Patent Publication No. 2014/0040011 is of interest for its disclosure of a way to display results of advertisement performance analysis on a mobile device.

Also of interest is U.S. Patent Publication No. 2016/0217407, which discloses a computerized sales and marketing process management system that allows data input and display through standard web browser or mobile app software. However, instead of enabling input of data by an advertisement sponsor or the subscriber to an advertisement management and/or tracking service, the input data and results in this system relate to analysis of sales employee performance by an employer, and in particular to goal setting and employee performance tracking.

U.S. Patent Publication No. 2008/0195462 is one of a number of additional patents and publications that serve as background on data collection related to website performance, including click analyses and the use of cookies, toolbars, and crawlers to collect information on website usage.

U.S. Patent Publication No. 2008/0040175 is representative of patents and publications directed generally to ad scoring techniques, in this instance involving feedback from viewers of the ads and modification of the ads in response thereto.

Additional background includes International Patent Publication No. WO/201514931, which discloses an algorithm for calculating advertising return on investment based on click rates and time spent viewing an advertisement; U.S. Patent No. 2006/0230053, which is representative of a number of patents and publications directed to targeting and pricing of advertisements based, at least in part, on consumer profiling; U.S. Patent Publication No. 2010/0138451, which is representative of patents and publications directed to placement of ads in webpages based on analysis of context; U.S. Pat. No. 6,006,197, which discloses advertising analysis based on correlation between Web tracking data such as click through and cookie data, and locally gathered and stored transaction data related to offline ordering of products; and U.S. Patent Publication No. 2002/0019768, which discloses an analysis system similar to that of U.S. Pat. No. 6,006,197.

Finally, U.S. Patent Publication Nos. 2014/0040008 and 2010/0138451, and U.S. Pat. Nos. 8,689,108, 8,645,199, 7,406,434, and 7,249,048 are of background interest for their general disclosures of advertising analysis software and display interfaces.

### SUMMARY OF THE INVENTION

The present invention is directed to a method and system for enabling the sponsor of an advertisement to score leads transmitted to the sponsor in response to an advertising service that displays the advertisements to potential clients or customers and collects information that can be used to contact the potential clients or customers. The term “sponsor” as used herein refers to a purveyor of the products or services being advertised, or to anyone else who can evaluate, score, or rate leads on behalf of the sponsor.

The method and system of the invention provides an interface to enable the sponsor to input characterizations of leads generated by responses to the advertisement. The generation of leads, and provision of a list of the generated leads, to the sponsor are carried out by a central or cloud-based advertisement management and analysis system such as Google Adwords, which connects to user interface software for implementing the present invention through an application programming interface (API) provided by the system provider. The present invention allows inputs by the sponsor to the advertising management and analysis system, including (a) inputs characterizing the leads provided to the sponsor and (b) feedback on the system's identification of those leads, which can used to improve the identification.

Although the illustrated embodiments involve an “app” (program instructions stored in a memory and executed by a processor of a mobile device such as a smartphone or tablet), and the person interacting with the device is referred to as a “mobile device user,” it will be appreciated by those skilled in the art that the interface may be implemented on any computing device controlled by the advertisement sponsor or an agent or associate of the sponsor, including conventional personal computers, workstations, and network terminals. While movement of fingers across a touchscreen is a preferred method of accomplishing the data input, equivalent “swiping” or “selecting” inputs may be accomplished by tracking of eye movements, gestures of user in three-dimensions, or use of a mouse to drag a slider or select a button, and therefore that the invention can be practiced on devices other than mobile devices with a conventional touchscreen.

A first exemplary embodiment of the invention enables the mobile device user to quickly and intuitively score the leads by inputting advertisement response data using one of two movements or gestures to interact with a graphic display on a touchscreen of the mobile device to score leads that have been provided to the user, based for example on information included in the lead display and/or on follow-up and interaction with the individuals or parties identified in the leads. The advertisement response can have one of two states (for example “yes” or “no”), and data entry is accomplished by performing a different gesture or motion relative to the display (for example, a right “swipe” or a left “swipe” as explained below) to indicate which of the states has been selected.

In a variation of the first exemplary embodiment, the lead may be scored on a sliding scale of values that can be selected by the user, for example by using a keypad, keypad display, or voice command to input a number, or by manipulating a movable object on the display such as a slider to select the number. The slider can represent a range of dollar amounts that indicate the value of the service or product purchased by the client or customer, or it could represent a favorability rating. The mobile app or software displays a list of leads, which are scored by the user. In this embodiment, at least two additional elements are displayed after selecting a lead, for example by touching the portion of the screen where the lead is displayed to trigger display of the two additional elements. The two additional elements may, for example, be representations of a slider and a select button. Upon display of the slider, the user moves his finger across the display to establish a desired position of the slider, after which the user touches the button to fix the position of the slider and establish and store an input value. Selection may be facilitated by displaying a dollar amount that varies with the position of the slider, or by displaying a series of dollar amounts at fixed positions relative to the slider.

In a second variation of the preferred embodiment, the slider is replaced by an array of selectable indicators, illustrated as stars, with each star having a value of one to five. Optionally, an “ok” button may be provided to confirm a selection. It will be appreciated that the slider shown in FIG. 2 and star array of FIG. 3 may be replaced by other icons or display devices for enabling a user to assign a value to a particular lead. For example, the stars may be replaced by any other shape, such as diamonds or emoticons.

In another exemplary embodiment, the interface implemented by the method and system of the invention may be utilized to provide training feedback regarding identification of lead types to a neural network or artificial intelligence engine that performs the lead type identification, in order to provide more accurate identification, which is useful to assist the advertisement sponsor in deciding which leads are worth a follow-up, or in assigning leads to appropriate divisions or personnel. Instead of having the mobile device user select or input a score by swiping or manipulating a slider, the interface implemented by this embodiment presents a lead type prediction generated by the neural network or artificial intelligence based program utilized by the advertisement management or analysis server. A label identifying the type or category of the lead is displayed on the mobile device together with a confirmation button having a “yes” or “no” option that allows the user to either verify that the label is accurate or to indicate that the label is inaccurate. If the user touches the area of the screen associated with the no button, indicating that the label is inaccurate, the mobile app or user software provides a list of alterative label options that can be selected by the user. Depending on the user's selection, a positive or negative score is uploaded to the advertising management server. Information on labels that do not match the initially-presented label are also set to the analysis software as feedback for the analysis performed by the artificial intelligence engine, which is used to refine the predictions made by the engine and enhance the listing of leads, such as the ones selected in the first and second embodiments of the invention.

In addition to providing a way to input scores, the interface-controlling mobile app or software may tabulate the scores by category for immediately display and/or upload to the advertising management and analysis system via the application programming interface (API). Optionally, the scores may be normalized to a predetermined standard range to facilitate the analysis before transmission to the advertising management and analysis system via the API.

While the lead scoring inputs of the invention may be utilized for a variety of purposes including, for example, setting prices for advertisements and to assist in their design, timing, and media selection, the lead scoring may also be used to determine which of a plurality of advertisements are best to purchase and display, based on a correlation between particular advertisements and high-scoring leads that resulted from the particular advertisements.

### BRIEF DESCRIPTION OF THE DRAWINGS

FIG. 1 is a schematic illustration of a mobile device display and method of lead scoring data input according to a first exemplary embodiment of the invention.

FIG. 1A includes screen shots of the mobile device display of FIG. 1.

FIG. 2 is a schematic illustration of a mobile device display and method of lead scoring data input according to a variation of the first exemplary embodiment of the invention.

FIG. 2A is a screenshot of the mobile device display of FIG. 2.

FIG. 3 is a schematic illustration of a mobile device display and method of lead scoring data input according to a second variation of the first exemplary embodiment of the invention.

FIG. 3A is a screenshot of the mobile device display of FIG. 3.

FIG. 4 is a schematic illustration of a mobile device display that permits input of training data for an advertising analysis program that utilizes artificial intelligence.

FIG. 4A is a schematic illustration of the mobile device display of FIG. 4, after a mobile device user has selected the “no” option.

FIGS. 4B and 4C are screen shots of the mobile device displays of FIGS. 4 and 4A.

### DETAILED DESCRIPTION OF THE PREFERRED EMBODIMENTS

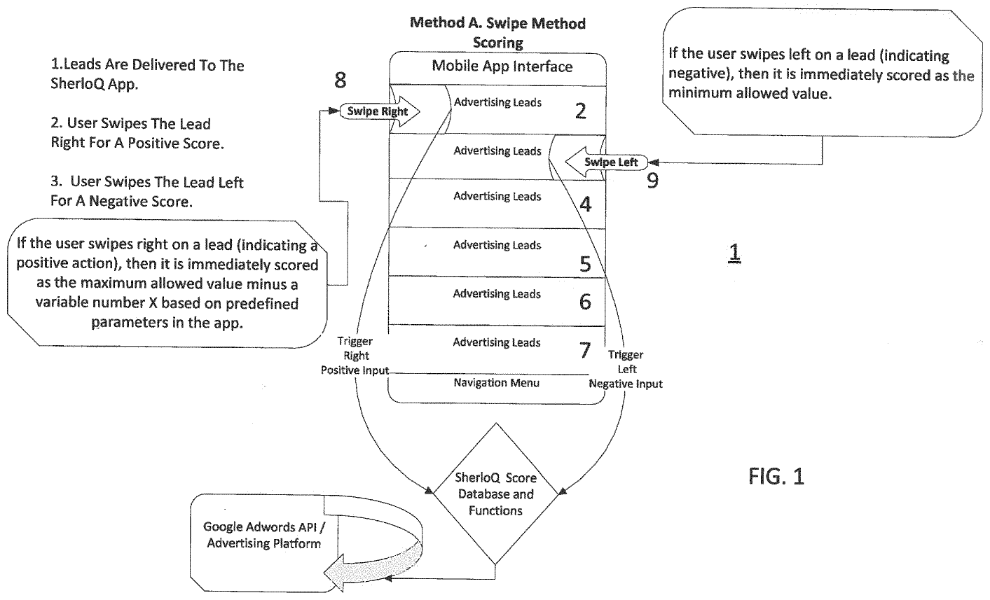

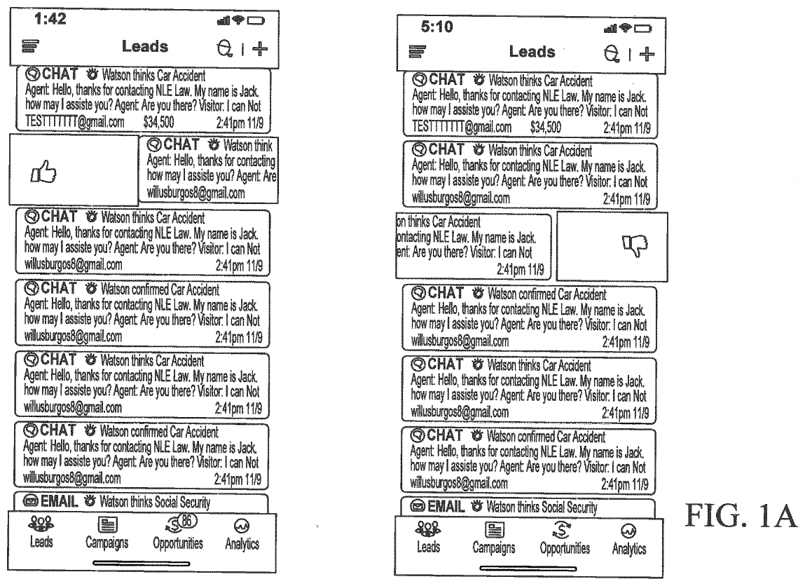

The method and system of the invention provides a way to score leads transmitted to the user in response to an advertising service that displays the advertisements to potential clients or customers and collects information that can be used to contact the potential clients or customers. For example, in response to the advertisement, the potential client or customer may input data through a web browser concerning the nature of the client's or customer's problem for which the client is seeking assistance, or a product or service sought by the client or customer, together with information that may be used to contact the client or customer. Alternatively, the potential client or customer may provide the information by calling a dedicated response number operated by the advertisement service, such as a toll-free number, with the information being transcribed and packaged as “leads” and transmitted to a mobile device app or browser software for display and rating in the manner illustrated in FIGS. 1, 1A, 2, 2A, 3, and 3A. The mobile device user may then provide feedback on the interaction in the form of a score, which is then sent to data analysis software of the advertisement management service. The feedback may be provided immediately based on information displayed in the leads, or after interaction with a potential client or customer listed in the lead.

An example of an existing service that can disseminate advertisements, collect leads, and provide them to the provider of products or services on whose behalf the advertisements were placed is the Google Adwords API/Advertising Platform, which provides a website or cloud-based interface for apps that assist users in developing advertisements and collecting leads. However, it will be appreciated that the invention is not limited to scoring of leads based on ads placed through Google Adwords, and that other ad placement and lead developing services may be utilized. In addition, while a mobile device is illustrated, the interface is not limited to mobile devices, as explained above.

FIG. 1 illustrates a preferred embodiment of the invention that enables the mobile device user to quickly and intuitively score the leads by inputting advertisement response data by using one of two movements or gestures to interact with a graphic display on a touchscreen of the mobile device to score leads that have been provided to the user. The advertisement response can have one of two states, and data entry is accomplished by performing a different gesture or motion relative to the display to indicate which of the states has been selected.

In the illustrated example, the states may indicate a positive or negative reaction to the information presented in the lead (such as the content of a chat), and/or may take into account follow-up interactions with the potential clients or customers identified in the lead.

The motion or gesture may be in the form of a “swipe,” meaning a sliding movement of the user's hand or finger(s) across the touchscreen display of the mobile device. The direction of the movement, for example in a rightward or leftward direction, is correlated to a positive or negative response. Appropriate software and display controller routines for detecting and distinguishing right and left swipe motions or gestures is well-known to mobile app developers.

The numerical values or scores correlated with the respective swipe motions may be tabulated, as explained below, by maintaining a running total of the numerical values and processing the total for upload to the central advertisement management and analysis software that provides the leads. The uploaded scores may be just one of many inputs processed by the analysis software, the inputs including data concerning the advertisement, historical data, and so forth, which are then processed to obtain a display of data and conclusions concerning the effectiveness of the advertisement, which may then be transmitted back to the mobile device for display or stored in a database accessible to the user.

As shown in FIGS. 1 and 1A, a mobile device interface in the form of a touch screen 1 is controlled to display a plurality of advertising leads 2-7 received by the advertisement manager or provider. The user then makes a determination as to whether the lead has value and inputs the results of the determination by swiping right or left, as indicated by arrows 8 and 9. If the user swipes right, as indicated by arrow 8, the lead is scored as the maximum allowed value for purposes of the analysis algorithm, while a left swipe, indicated by arrow 9, results in a minimum allowed value. The minimum and maximum allowed values may optionally be adjusted for different leads according to criteria determined by the mobile app or software that controls the interface. In the screen shot of FIG. 1A, the list of leads is shown in the form of “chat” transcripts. In the left screen shot, the mobile user has swiped right to indicate a valuable lead, while the right screen shot shows the result of a leftward swipe to indicate an unproductive lead.

The scores are then processed to provide a running total or score that is adjusted up or down with each swipe, after which the running total may optionally be normalized according to the following formula:

Score=v−a/b−a(d−c)

where v is the final score or running total, a is the maximum possible score, b is the minimum possible score, c is the minimum score in the range of scores is to be mapped, and d is the maximum score to which the range of scores is to be mapped. For example, if the scores for the mobile app are between −5 and 5, but the range of scores recognized by Adwords is between 0 and 10, a score of 2 would be mapped to 7. This score can then be provided to the ad service, for example Google Adwords, as data for evaluating the effectiveness of the ad. Those skilled in the art will appreciate that the scoring may be carried out by the application programming interface using a programming language such as Python.

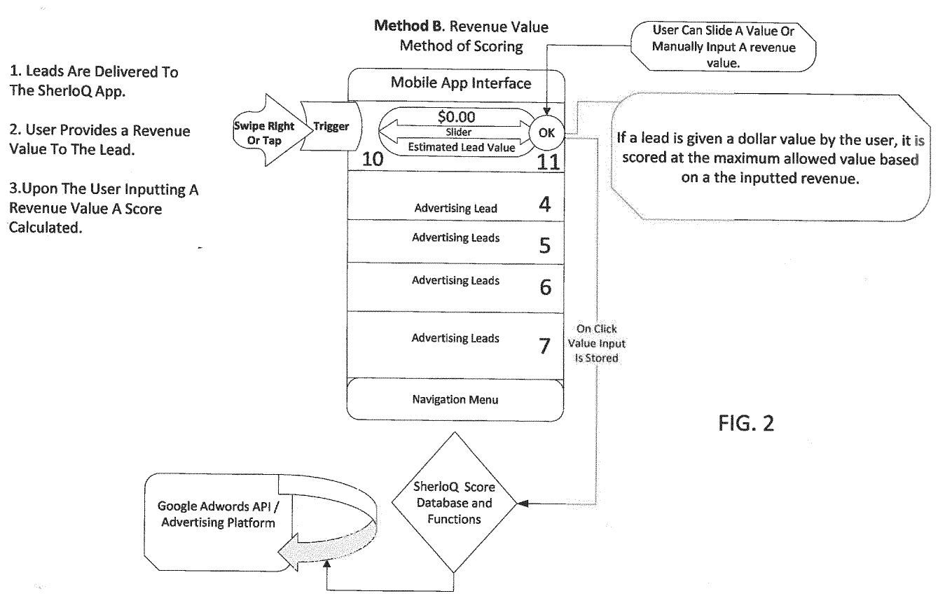

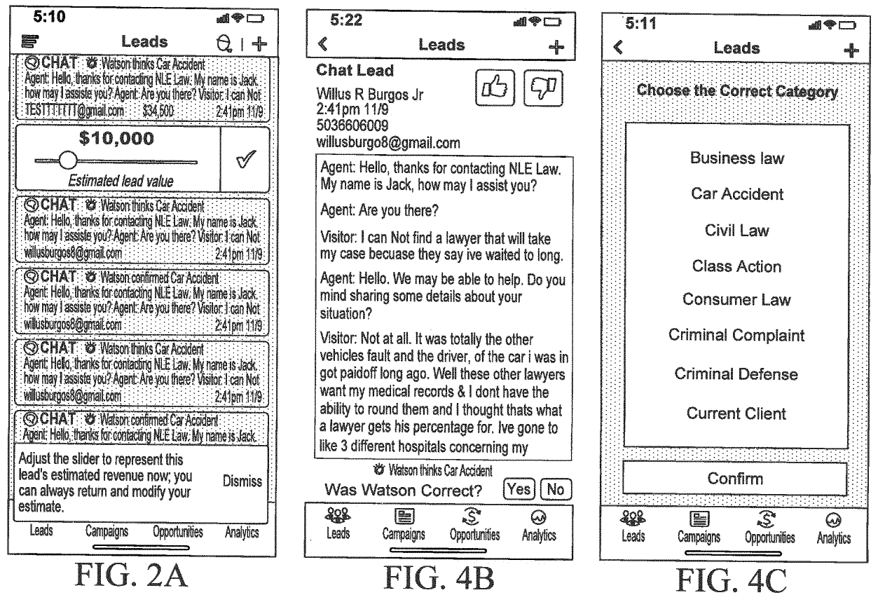

In the variation of the exemplary embodiment shown in FIGS. 2 and 2A, which may replace the embodiment of FIG. 1 or be implemented as an optional alternative method selectable by the user, the lead may be scored on a sliding scale of values that can be input or selected by the user, for example by manipulating a movable object on the display such as a slider such as the one shown in the screen shot of FIG. 2A. For example, the slider can represent a range of dollar amounts that indicate the value of the service or product purchased by the client or customer. As illustrated in FIGS. 2 and 2A, the mobile app or software again displays a list of leads, which are scored by the user. In this embodiment, at least two additional elements are displayed after selecting a lead, for example by touching the portion of the screen where the lead is displayed to trigger display of the two additional elements, which are a slider 10 and a select button 11. Upon display of the slider, the user moves his finger across the display to establish a desired position of the slider, after which the user touches the button 11 to fix the position of the slider 10 and establish and store an input value. Selection may be facilitated by displaying a dollar amount that varies with the position of the slider, or by displaying a series of dollar amounts at fixed positions relative to the slider. FIG. 2A is a screen shot showing a slider that has been positioned to indicate a monetary value of $10,000, and a selected confirmation button (in the form of a check mark).

The dollar amounts may again be normalized or mapped to a predetermined minimum and maximum according to the algorithm described above in connection with FIG. 1 before transmission to the advertisement management and analysis service for analysis, the input score for each may be transmitted directly to the ad service upon input, or a total of input dollar amounts may be transmitted directly to the advertising management and analysis service that provides the leads.

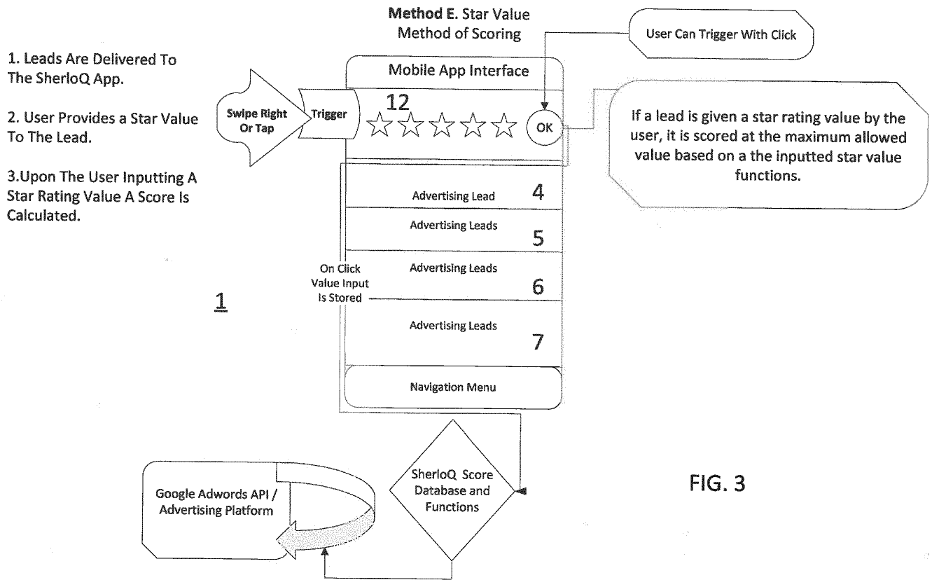

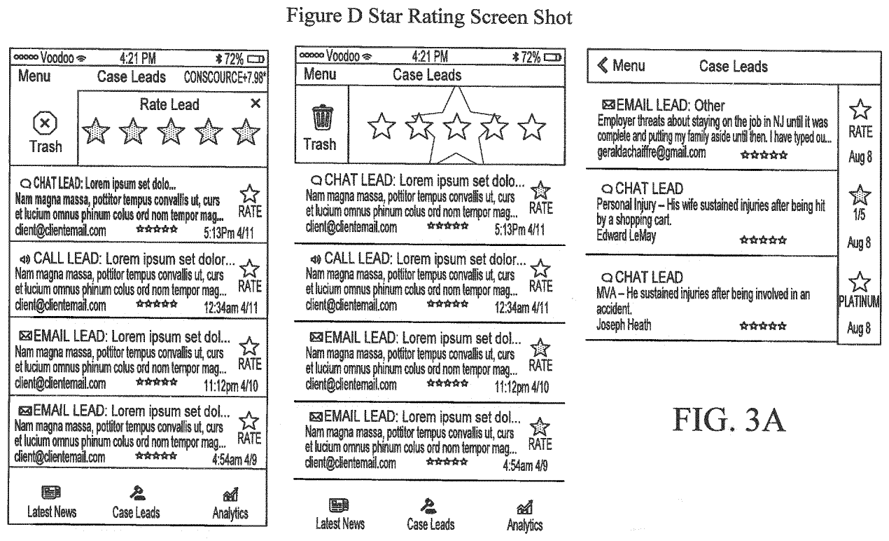

As alternative to a slider, the score input for a lead may be replaced by a series or array of selectable shapes or icons, whose position is indicative of the score. By way of example and not limitation, as shown in FIG. 3 and in the screen shot of FIG. 3A, the shapes or icons may be in the form of an array of stars 12 that, for five stars, enables input of a rating of one to five. The number of shapes or icons, and the shapes themselves, may of course be varied by those skilled in the art without affecting the functionality of the display.

Once the leads are scored and the information provided to the advertisement management and analysis service, the scores may be used to set prices for the advertisements, assist in their design, timing, and media selection, select which advertisements to purchase and display, and/or for any other purpose for which the scores for respective leads provide useful information.

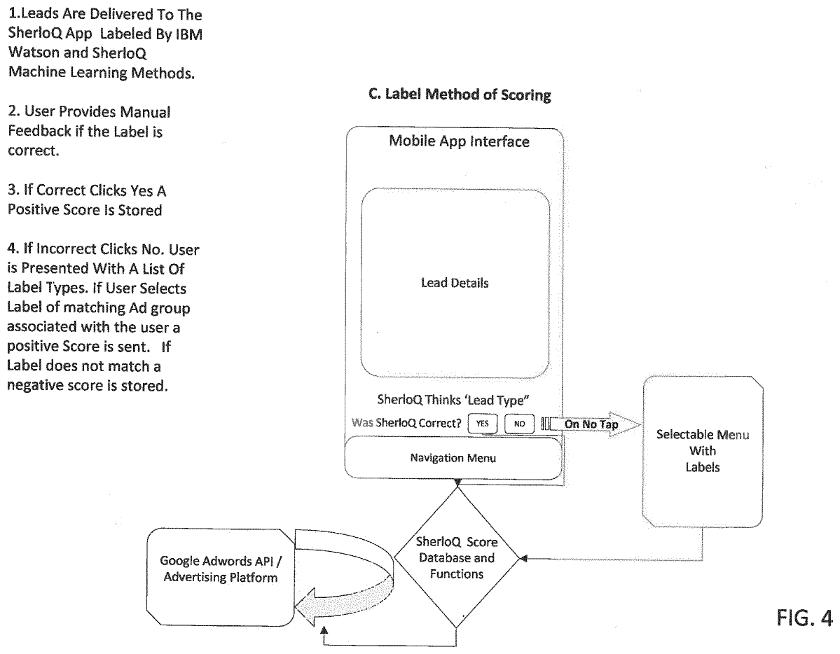

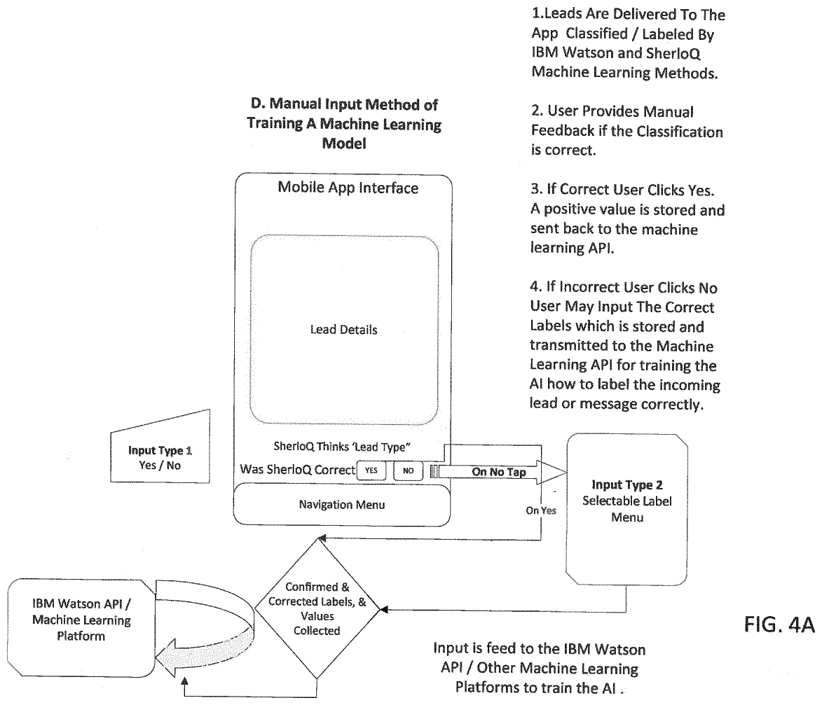

A second embodiment of the input method and system of the invention is illustrated in FIGS. 4 and 4A. This embodiment is utilized in a lead type identification function of the advertisement management and evaluation system, and in particular to provide feedback to a neural network that performs the lead type analysis. Instead of having the user select a score from options by swiping or manipulating a slider, this option presents a lead type prediction generated by the neural network or artificial intelligence-based program utilized by the ad management server. The “lead types” may include, by way of example and not limitation, leads identified by the nature of the problem for which the advertiser's service is requested, such as “car accident,” “medical malpractice,” “taxes,” or “divorce.”

The evaluation program may utilize an artificial intelligence engine such as Watson to develop a label identifying the type or category of the lead, which is displayed on the mobile device together with a confirmation button having a yes or no option that allows the user to either verify the label is accurate or to indicate that the label is inaccurate. If the user touches the area of the screen associated with the “no” button, shown in FIG. 4, the mobile app or user interface controlling software provides a list of alterative label options that can be selected by the user, as shown in FIG. 4A. Depending on the user's selection, a positive or negative score is uploaded to the advertising management server. Information on labels that do not match the initially-presented label are also set to the analysis software as feedback for the analysis performed by the artificial intelligence engine, which is used to refine the predictions made by the engine and enhance the listings of leads in the embodiments of FIGS. 1 to 3. FIGS. 4B and 4C are respective screen shots of for the arrangement of FIG. 4 and an example of an alternative label listing corresponding to the alternative label listing of FIG. 4A.

What is claimed is:

1. A method of training a provider of a list of leads generated based on responses to an advertisement to more accurately identify the leads, comprising the steps of:
displaying a lead type identifier and selectable icons respectively indicative of whether the lead type identifier is accurate or inaccurate;
upon selection of an icon that indicates that the identifier is accurate, notifying the provider that the list type identifier is accurate;
upon selection of an icon that indicates that the identifier is inaccurate, displaying a list of potential identifiers, and
upon selection of one of the potential identifiers, uploading the selected potential identifier to the provider for use as a teaching input to refine identification of lead types.

2. A system for training a provider of a list of leads generated based on responses to an advertisement to more accurately identify the leads, comprising a memory, a processor, and a set of display control instructions stored in the memory and executable by the processor, the set of display control instructions including instructions for:
displaying a lead type identifier and selectable icons respectively indicative of whether the lead type identifier is accurate or inaccurate;
upon selection of an icon that indicates that the identifier is accurate, notifying the provider that the list type identifier is accurate;
upon selection of an icon that indicates that the identifier is inaccurate, displaying a list of potential identifiers, and
upon selection of one of the potential identifiers, uploading the selected potential identifier to the provider for use as a teaching input to refine identification of lead types.
